(19) United States
(12) Patent Application Publication
(10) Pub. No.: US 2006/0103746 A1
(43) Pub. Date: May 18, 2006

(54) Image capture device

(76) Inventors: Keiichi Mori, Hachioji-shi (JP); Yuichi Gomi, Hachioji-shi (JP); Seisuke Matsuda, Hachioji-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/274,902

(22) Filed: Nov. 15, 2005

(30) Foreign Application Priority Data
Nov. 17, 2004 (JP) 2004-333495

(51) Int. Cl. H04N 5/335

(52) U.S. Cl. 348/294

(57) ABSTRACT

An image capture device comprises an imaging unit which includes a plurality of output terminals and a light receiving unit composed of a plurality of pixels arranged in the form of an array of columns and rows and each having a photoelectric conversion element which, upon receiving light, produces a photoelectric conversion output signal, and wherein the imaging unit is configured to output photoelectric conversion output signals from the pixels onto the output terminals, signal amplifiers each of which is connected to a corresponding respective one of the output terminals, a detection unit which, after the photoelectric conversion output signals have reached a saturation level, detects the magnitude of saturation output signals from the output terminals, and a setting unit which sets the gains of the respective signal amplifiers so that the saturation output signals detected by the detection unit become equal in magnitude to one another.

### CROSS-REFERENCE TO RELATED APPLICATIONS

This application is based upon and claims the benefit of priority from prior Japanese Patent Application No. 2004-333495, filed Nov. 17, 2004, the entire contents of which are incorporated herein by reference.

### BACKGROUND OF THE INVENTION

1. Field of the Invention

The present invention relates to a technique to adjust a difference in output signal between output channels in an image capture device having plural output channels.

2. Description of the Related Art

If there is a difference in gain between signal paths onto which image output signals of an imaging device having two output channels are simultaneously output, a difference occurs between image signal levels on the channels, causing transverse streaks and flicker to appear on a display screen.

To solve this problem, a technique has been proposed which determines the gain of an AGC circuit on one channel by a gain control circuit according to captured brightness level and, on the basis of this gain and stored gain characteristic, determines the gain of an AGC circuit on the other channel in an operation unit (see Japanese Unexamined Patent Publication No. 9-200619).

### BRIEF SUMMARY OF THE INVENTION

According to a first aspect of the invention, there is provided an image capture device comprising: an imaging unit which includes a plurality of output terminals and a light receiving unit composed of a plurality of pixels arranged in the form of an array of columns and rows and each having a photoelectric conversion element which, upon receiving light, produce a photoelectric conversion output signal, and wherein the imaging unit is configured to output photoelectric conversion output signals from the pixels onto the output terminals; signal amplifiers each of which is connected to a corresponding respective one of the output terminals of the imaging unit; a detection unit which, after the photoelectric conversion output signals have reached a saturation level, detects the magnitude of saturation output signals from the output terminals of the imaging unit; and a setting unit which sets the gains of the respective signal amplifiers so that the saturation output signals detected by the detection unit become equal in magnitude to one another.

According to a second aspect of the invention, there is provided an image capture device comprising: an imaging unit which includes a plurality of output terminals and is configured to output image information having color information onto the output terminals; a select unit which selects output terminals out of the output terminals of the imaging unit onto which image information captured by the imaging unit are to be output; a setting unit which sets the gains of signals output onto the selected output terminals of the imaging unit so that saturation output signals output from the selected output terminals become equal to each other in magnitude; and an AD converter unit which converts image information amplified on the basis of the gains set by the setting unit from analog to digital form.

According to a third aspect of the invention, there is provided an image capture device comprising: imaging means which includes a plurality of output terminals and a light receiving unit composed of a plurality of pixels arranged in the form of an array of columns and rows and each having a photoelectric conversion element which, upon receiving light, produces a photoelectric conversion output signal, wherein the imaging means is configured to output photoelectric conversion output signals from the pixels onto the output terminals; signal amplifying means each of which is connected to a corresponding respective one of the output terminals of the imaging means; detecting means for, after the photoelectric conversion output signals have reached a saturation level, detecting the magnitude of saturation output signals from the output terminals of the imaging means; and setting means for setting the gains of the respective signal amplifying means so that the saturation output signals detected by the detecting means become equal in magnitude to one another.

According to a fourth aspect of the invention, there is provided an image capture device comprising: imaging means which includes a plurality of output terminals and is configured to output image information having color information onto the output terminals; selecting means for selecting output terminals out of the output terminals of the imaging means onto which image information captured by the imaging means are to be output; setting means for setting the gains of signals output onto the selected output terminals of the imaging means so that saturation output signals output from the selected output terminals become equal to each other in magnitude; and AD conversion means for converting image information amplified on the basis of the gains set by the setting means from analog to digital form.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of an image capture device according to a first embodiment of the present invention;

FIG. 2 shows the imaging circuit and its associated circuits;

FIG. 3 shows an arrangement of color filters in the imaging device;

FIG. 4 shows a string of color signals read from each channel in the case of two-channel readout;

FIG. 5 shows a string of color signals read from each channel in the case of four-channel readout;

FIG. 6 shows amplifier output versus light amount;

FIG. 7 shows amplifier output versus light amount;

FIG. 8 is a schematic flowchart for correction coefficient calculation processing;

FIG. 9 is a schematic flowchart for capture time processing;

FIG. 10 shows the circuit arrangement of the imaging device;

FIG. 11 is a timing diagram illustrating the operation in the two-channel readout mode;

FIG. 12 is a timing diagram illustrating the operation in the four-channel readout mode;

FIG. 13 shows the imaging circuit and its associated circuits; and

FIG. 14 shows a CMOS output waveform from an optical black portion and a CMOS output waveform during an imaging interval.

### DETAILED DESCRIPTION OF THE INVENTION

### First Embodiment

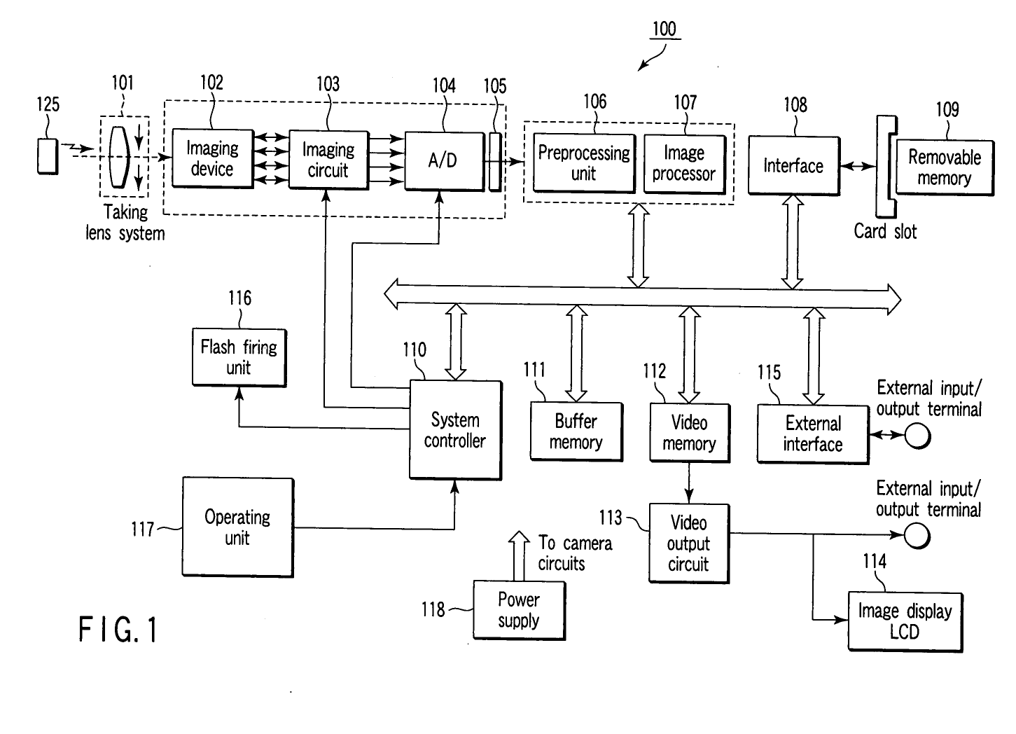

FIG. 1 is a block diagram of an image capture device according to a first embodiment of the present invention.

The image capture device 100 includes a taking lens system 101, an imaging device 102, an imaging circuit 103, an analog-to-digital converter 104, an output select unit 105, a preprocessing unit 106, an image processor 107, an interface unit 108, a card slot 109, a system controller 110, a buffer memory 111, a video memory 112, a video output circuit 113, an image display LCD 114, an external interface unit 115, a flash firing unit 116, and an operating unit 117.

The taking lens system 101 includes a zoom lens system, an aperture, and an autofocus lens system. The imaging device 102 has a light receiving unit comprised of, say, several millions of pixels and converts a subject image captured through the taking lens system 101 into an electric signal. The imaging device 102 is configured to output pixel signals onto its plural output channels. The imaging circuit 103 performs signal processing, such as AGC (automatic gain control) processing, CDS (correlated double sampling) processing, etc. The analog-to-digital converter 104 converts each analog image signal output from the imaging circuit 103 into digital image data. The output select unit 105, under instructions of the system controller 110, selects given channels out of plural output channels of the analog-to-digital converter 104 and outputs image data on the selected channels to the succeeding stage.

The preprocessing unit 106 carries out processing associated with AE (automatic exposure) and AF (autofocusing) on the basis of the image data. The image processor 107 performs processing such as Y (brightness)/C (color) production processing, color matrix processing regarding RGB signals having a proper color balance, etc. The interface unit 108 is one that communicates image data with a removable memory 126 loaded into the card slot 109. The system controller 110 exercises control over the entire image capture device 100. The buffer memory 111 temporarily stores image data and so on. The video memory 112 temporarily stores Y (brightness) data and C (color) data output from the image processor 107. The video output circuit 113 converts data in the video memory 112 into analog brightness and color signals and provides them to the image display LCD 114. These signals may be output to an external device (not shown) via external input/output terminals. The external interface unit 115 is a communication interface that communicates adjustment values and other information with a terminal device (not shown) such as a personal computer (PC).

The flash firing unit 116 is mounted so that it can communicate with the system controller 110 via a flash communication connector (not shown). The operating unit 117 is composed of switches, a jog dial, etc., which are used by the user in performing input operations. The user is allowed to perform shooting or playback operations such as a release operation, mode setting, battery display selection, etc. A power supply 118 provides a required supply voltage to each component of the image capture device 100.

An adjustment light source 125 is used in adjusting the output difference between the output channels of the imaging unit 102. The adjust operation will be described later.

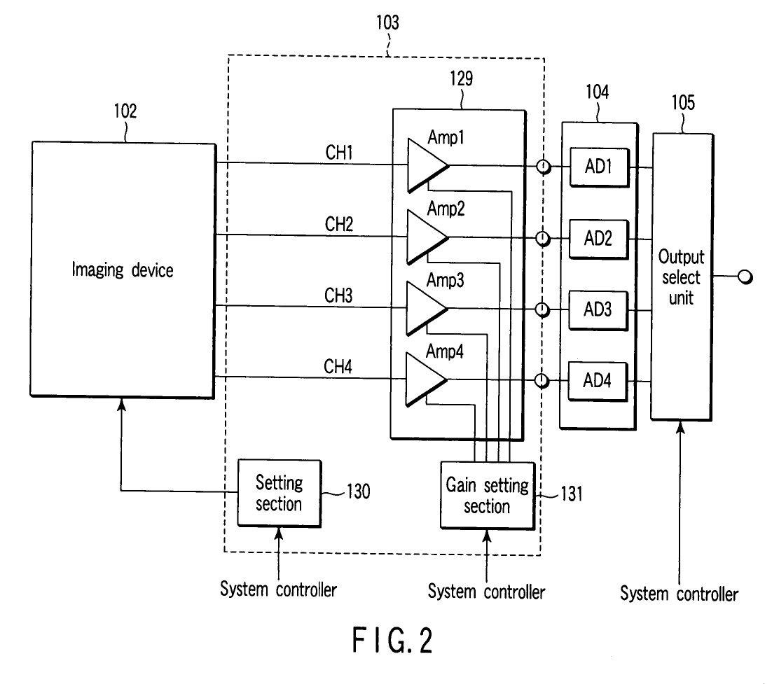

FIG. 2 shows the imaging circuit 103 and its associated circuits. The arrangement and operation of the imaging circuit 103 and its associated circuits will be described with reference to FIG. 2.

The imaging device 102 is equipped with output channels CH1 through CH4 onto which pixel signals are output. Analog pixel signals read onto the output channels CH1 through CH4 are amplified by amplifiers Amp1 through Amp4, respectively, of an amplification section 129 in the imaging circuit 103. The analog pixel signals are each converted into a digital signal by a corresponding respective one of the converters AD1 through AD4 in the analog-to-digital converter 104. The output selection unit 105 reads out digital image data on the output channels selected out of the output channels CH1 through CH4 of the imaging device 102 and sends them to the succeeding preprocessing unit 106. If, at this point, there is a difference in gain among the amplifiers Amp1 through Amp4, transverse streaks, flicker and changes in color will occur on the image display screen.

Here, methods of reading pixel signals from the imaging device 102 include two-channel readout in which pixel signals are read out onto the two output channels CH1 and CH2 and four-channel readout in which pixel signals are read out onto the four output channels CH1 through CH4. The four-channel readout is used in a fast read mode (for example, in the continuous shooting mode).

A setting section 130 controls the operation of the imaging device 102 and instructs it to switch between the two-channel readout and the four-channel read operations under the control of the system controller 110. A gain setting section 131 sets the gain of each of the amplifiers Amp1 through Amp4 under the control of the system controller 110. The output selecting unit 105 carries out a select operation corresponding to a signal indicating two-channel or four-channel readout from the system controller 110.

Next, a method of adjusting the amplifier gain difference in the image capture device according to the first embodiment of the present invention will be described. This adjusting method adjusts the gain of each of the amplifiers Amp1 through Amp4 on the basis of pixel signals which are read out of the imaging device 102 by irradiating the image capture device 100 with light from a gain adjusting light source 125.

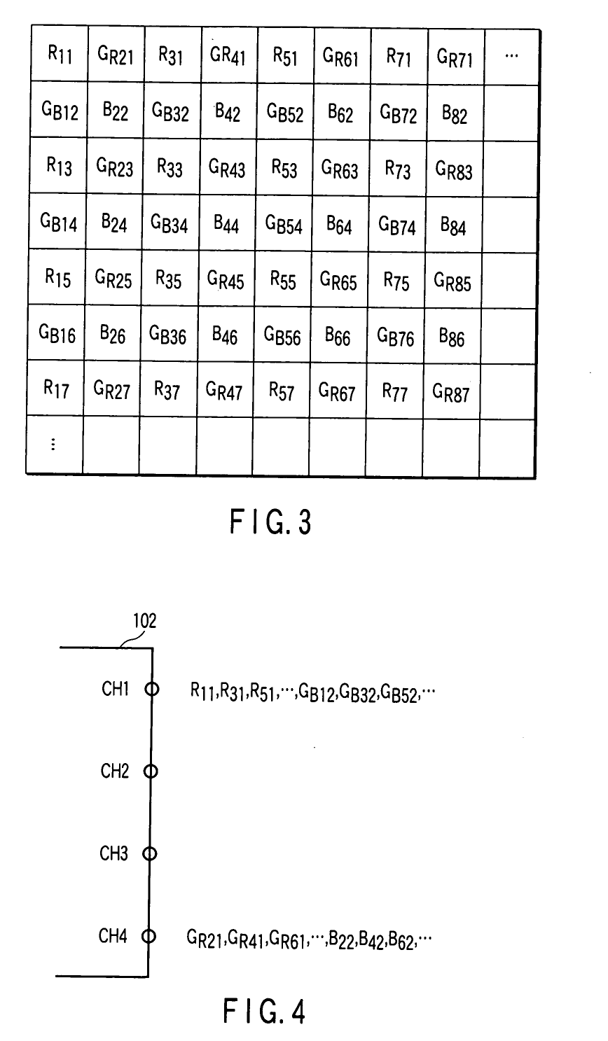

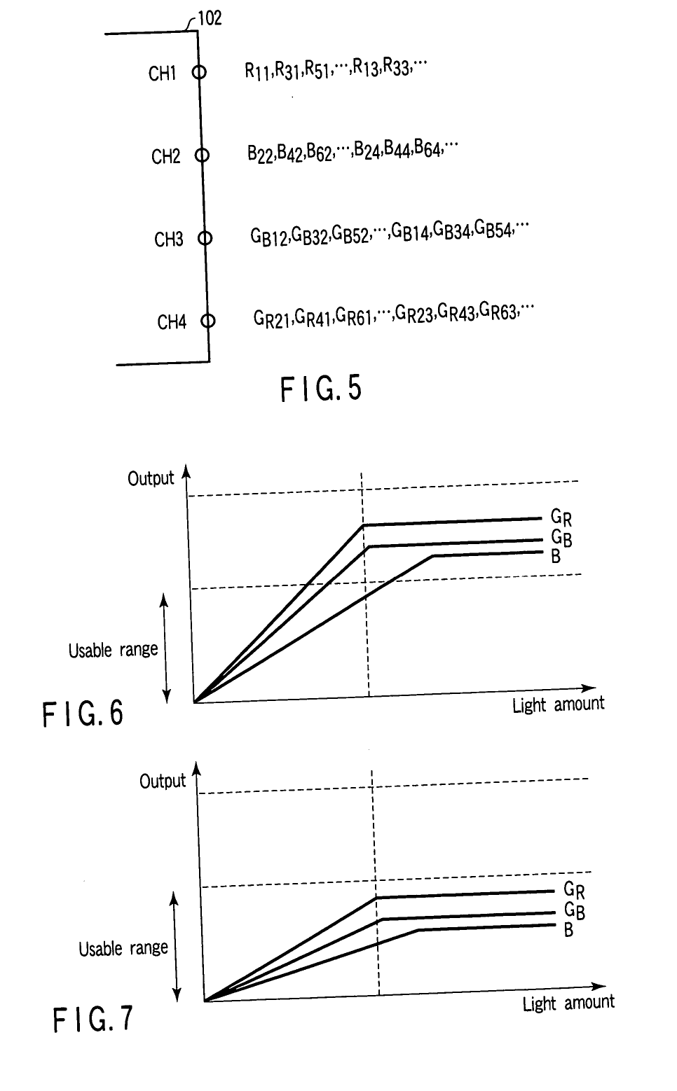

FIG. 3 shows an arrangement of color filters in the imaging device 102. FIG. 4 shows a string of color signals read over each channel in the case of two-channel readout. FIG. 5 shows a string of color signals read over each channel in the case of four-channel readout.

The gain difference adjusting method will be described in terms of four-channel readout by way of example. In the four-channel readout, the outputs of the amplifiers Amp1 through Amp4 correspond to four color signals R, B, GB, and GR, respectively, as shown in FIG. 5. When the intensity of light (the amount of light) from the light source 125 is changed, the output levels of the amplifiers Amp1 through Amp4 change accordingly. FIG. 6 shows amplifier output versus light amount. In FIG. 6, plots only for the color signals B, GR and GB are illustrated in order to simplify the description.

As shown in FIG. 6, the output level of the amplifier increases with increasing amount of light but, when the amount of light is increased to more than a predetermined level, the pixels are saturated to fix their output level at a constant value. In FIG. 6, the amounts of light at which the color signals B, GR and GB are saturated differ from one another. This is because the sensitivity to the adjustment light source 125 differs for each of the color filters provided on the pixels in the imaging device 102. It is desirable that each of the image signals handled by the image capture device 100 hold a linear relationship between light amount and output level. For this reason, exposure is controlled so that the output level of each of the amplifiers Amp1 through Amp4 is set to within a usable region in which the light amount versus output level relationship is linear. The conventional gain adjustment is also made on the basis of image signals within the usable region.

In contrast, we paid attention to the saturated state of pixels which are operated in a region beyond the usable region. That is, the output of the pixel in the saturated state (hereinafter referred to as the saturation output value) is determined by the storage capacity of the imaging device independently of color. Thus, we have come to realize that the characteristic in the usable region can be adjusted by adjusting the gains of the amplifiers Amp1 through Amp4 so that the saturation output values become equal to one another.

To implement the technical concept, such a gain as lowers specially the sensitivity to light (for example, ½ gain) is set in the amplifiers as shown in FIG. 7. The gain of the conventional amplifiers can be changed to ×1, ×2, ×4, . . . , and ×32 each time the ISO sensitivity is increased by a factor of two at shooting time. In implementing our technical concept, however, even if the gain has been set to ×1, or the minimum value, it becomes impossible in some instances to read the saturation output values at adjustment time because they become too great.

Thus, after the gain of each amplifier has been adjusted to a readable saturation output value, the gains of the respective amplifiers Amp1 through Amp4 are adjusted so that the saturation output values of the respective channels become equal to a maximum saturation value.

That is, suppose that, with the current gains of the amplifier Amp1 (i=1, . . . , 4) as Gi and the correction coefficients as gi, the new gain G′i is expressed by
G′i=gi×Gi (1)
Then, the correction coefficients gi are expressed using the saturation output values Si as follows:
gi=Max(S1, S2, S3, S4)/Si (2)
where Max(S1, S2, S3, S4) is a function representing the maximum value of S1, S2, S3, and S4.

In this manner, the gains of the amplifiers Amp1 through Amp4 are adjusted so that the saturation output values are made equal to one another. After that, the output values of the amplifiers Amp1 through Amp4 after gain adjustment are made to meet the full range of the analog-to-digital converter 104 over which analog-to-digital conversion can be made. That is, since attention is paid to only the saturation output values in expressions (1) and (2), a mismatch may occur between the output characteristics after correction and the effective range of the analog-to-digital converter 104 depending on circumstances. Thus, using a correction coefficient k to cause the output values to meet the full range of the analog-to-digital converter 104, new gains G′i may be defined by
G′i=k×gi×Gi (3)

It is desirable to provide the correction coefficient k for each of the amplifiers Amp1 through Amp4 and allow the resulting correction coefficients ki to be adjusted individually. This is to allow corrections due to other factors.

The aforementioned concept of gain adjustment is not restricted to the four-channel readout but is applicable to the two-channel readout as well.

Next, the procedure of adjusting the gains on the basis of the aforementioned concept will be described. With this gain adjustment method, the correction coefficients gi are calculated in a step of manufacture of the image capture device 100 and stored. After shipment of the device, image processing is performed using the correction coefficients gi when the user has taken a picture.

The adjustment procedure may be implemented by causing adjustment software previously built into the image capture device to run or using an external personal computer in combination with the image capture device.

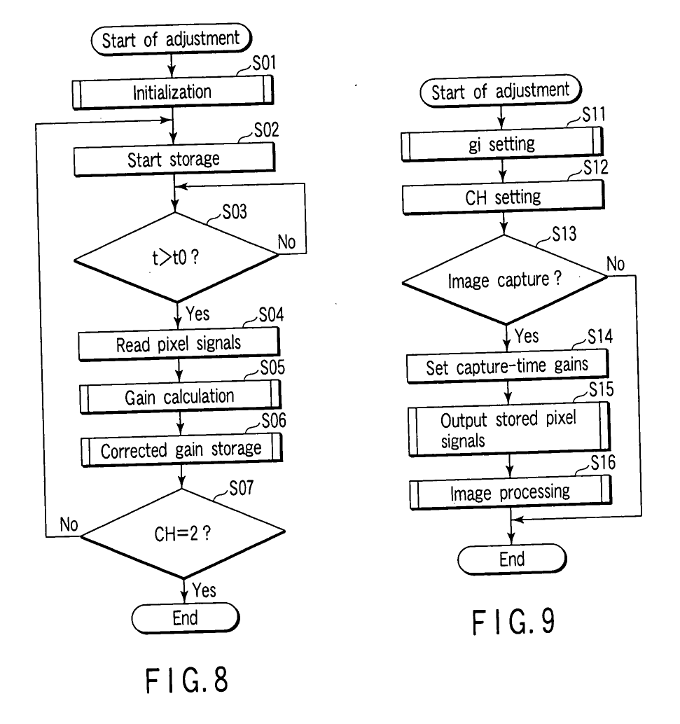

A person who makes adjustments irradiates the image capture device 100 with light from the light source 125. The light source 125 is made of a uniformly diffused light source. However, since saturation output values are used in adjustment as described above, any other light source may be used provided that it can emit an amount of light large enough to saturate pixel outputs. Next, when the person turns on an adjustment mode switch (not shown) provided on the image capture device 100 by way of example, the image capture device 100 carries out a correction coefficient calculation process shown in FIG. 8.

In step S01 of FIG. 8, an initialization process is carried out. In this initialization process, the gain of each amplifier is set to an adjustment gain of, say, ½. After the image capture device has been set to the four-channel readout mode, processes, such as initialization of the timer, draining away of remaining charges in the imaging device 102, resetting of internal parameters, etc., are carried out.

In steps S02 and S03, charge storage based on light from the light source 125 is started and then the device is placed in the wait state until a time t0 required for pixels to saturate elapses. After the lapse of the saturation time t0, the outputs of the respective amplifiers Amp1 through Amp4 are read in. The values read at this point corresponding to the saturation output values S1 through S4. Since the gain of each amplifier is lowered to ½ as described above, the saturation output values can be set to within a range over which analog-to-digital conversion is possible.

In steps S05 and S06, the correction coefficients gi or k×gi are calculated using expressions (1), (2) and (3) and then stored.

In step S07, a decision is made as to whether the processing for two-channel readout has been carried out or not. If not, a return is made to step S02 in which the correction coefficients gi in the two-channel readout are calculated and then stored. By the above procedure, the correction coefficients for the two-channel and four-channel readout are calculated and stored.

After that, when the user turns on the power to the image capture device 100, such a capture-time process as shown in FIG. 9 is carried out.

In step S11 of FIG. 9, the stored correction coefficients gi are read and then set in the gain setting section 131. In step S12, a decision is made as to which of the four-channel readout mode and the two-channel readout mode is to be used on the basis of the operation mode of the image capture device 100. The mode to be used is then set in the imaging device 102 and the output select unit 105.

When YES in step S13, that is, when image capture has been performed, the gain setting section 131 adjusts the gains of the respective amplifiers Amp1 through Amp4 using the correction coefficients gi in steps S14 to S16. The pixel signals are read from the imaging device 102, then amplified with the adjusted gains and converted into digital image data. Image processing is then performed on the resulting digital image data.

Next, the configuration and operation of the imaging device 102 to implement the two-channel and four-channel readout.

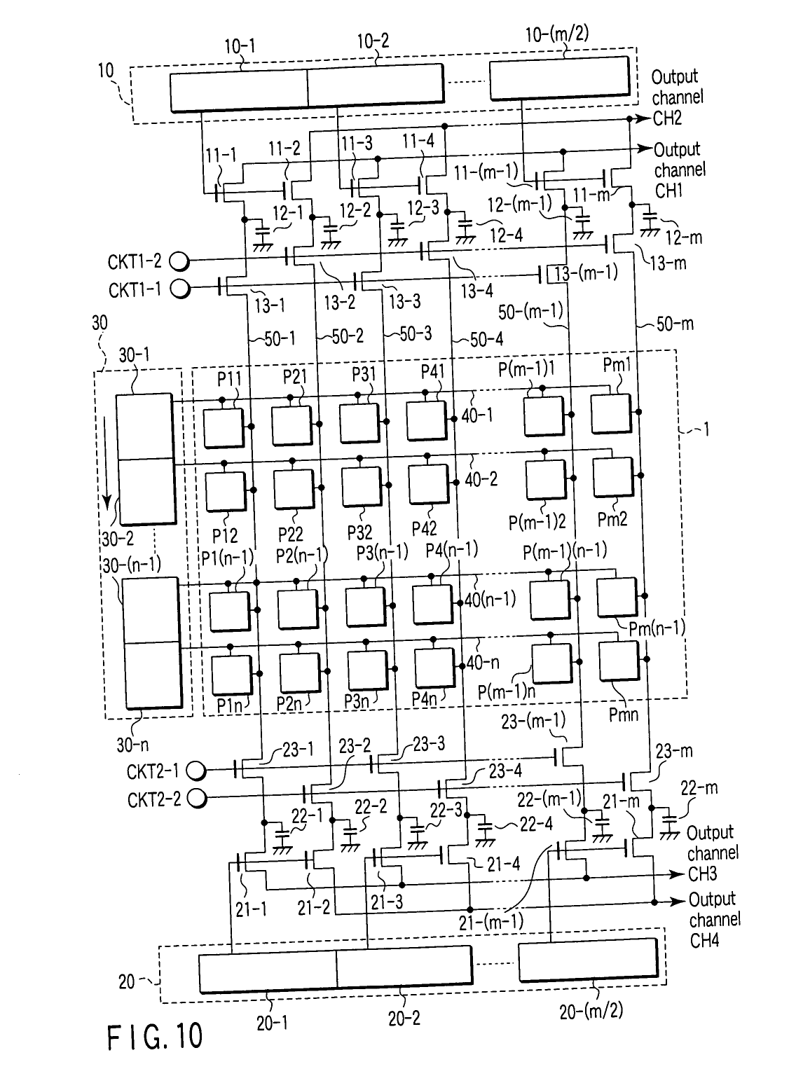

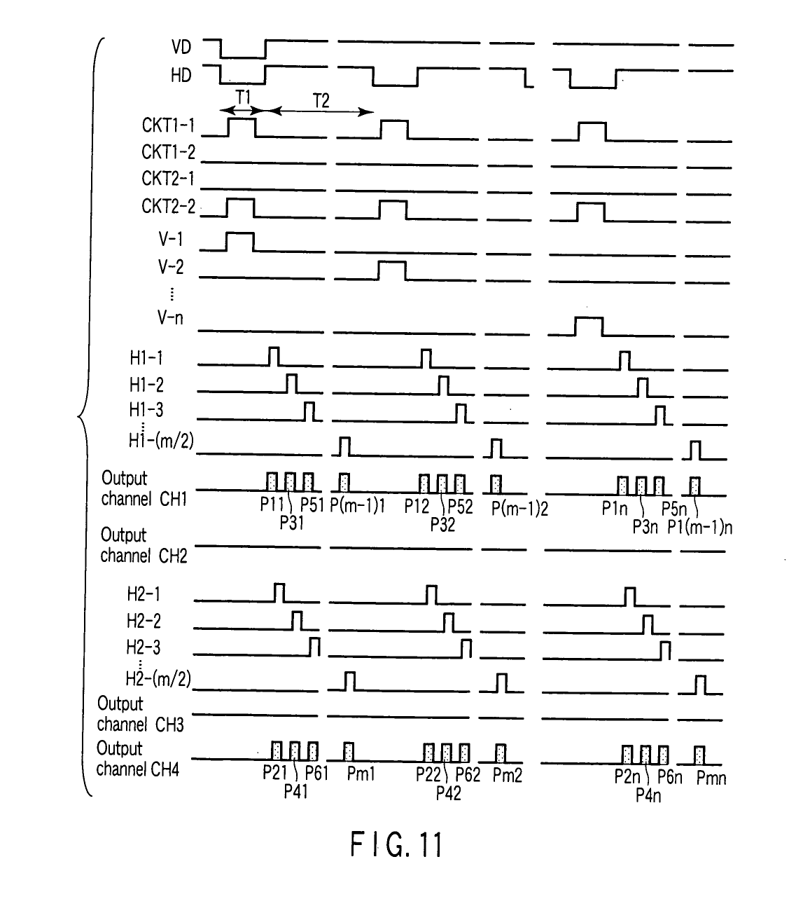

FIG. 10 shows the configuration of the imaging device 102. In this figure, P11, . . . , Pmn (m and n are integers) denote m×n pixels arranged in the form of a two-dimensional array of rows and columns. Reference numeral 1 denotes the light receiving unit composed of these pixels.

Reference numeral 30 denotes a vertical scanning circuit, which scans lines 40-1, 40-2, . . . , 40-n in sequence and has units 30-1, 30-2, . . . , 30-n corresponding to the lines 40-1, 40-2, . . . , 40-n.

Reference numerals 10 and 20 both denote horizontal scanning circuits, which are adapted to read out each of electrical pixel signals output from the pixels P11, . . . , Pmn onto output signal lines 50-1, 50-2, . . . , 50-m in sequence in the horizontal direction.

The horizontal scanning circuit 10 is comprised of units 10-1, 10-2, . . . , 10-m corresponding to the horizontal signal lines 50-1, 50-2, . . . , 50-m. likewise, the horizontal scanning circuit 20 is comprised of units 20-1, 20-2, . . . , 20-m corresponding to the horizontal signal lines 50-1, 50-2, . . . , 50-m.

Though not shown, each of the pixels P11, . . . , Pmn is connected with other lines than a scan line and a output signal line.

The output signal lines 50-1, 50-2, . . . , 50-m have their one ends on the horizontal scanning circuit 10 side respectively connected to transistors 13-1, 13-2, . . . , 13-m, line memories 12-1, 12-2, . . . , 12-m, and transistors 11-1, 11-2, . . . , 11-m.

On the other hand, the other ends of the output signal lines 50-1, 50-2, . . . , 50-m on the horizontal scanning circuit 20 side are respectively connected to transistors 23-1, 23-2, . . . , 23-m, line memories 22-1, 22-2, . . . , 22-m, and transistors 21-1, 21-2, . . . , 21-m.

The transistors 13-1, 13-2, . . . , 13-m, 23-1, 23-2, . . . , 23-m serve as transfer switches adapted to transfer signals on a row selected by the vertical scanning circuit 30 to the line memories 12-1, 12-2, . . . , 12-m, 22-1, 22-2, . . . , 22-m and are turned on or off by control signals CKT1-1, CKT1-2, CKT2-1, and CKT2-2. Each of the control signals CKT1-1 and CKT1-2 is applied in common to alternate ones of the transistors 13-1, 13-2, . . . , 13-m. Each of the control signals CKT2-1 and CKT2-2 is applied in common to alternate ones of the transistors 23-1, 23-2, . . . , 23-m. Hereinafter, each of the transistors 13-1, 13-2, 13-m, 23-1, 23-2, . . . , 23-m is referred to as the transfer switch.

The line memories 12-1, 12-2, . . . , 12-m, 22-1, 22-2, . . . , 22-m are each comprised of a capacitor to temporarily store a pixel signal transferred from each of pixels arranged in a corresponding column through a corresponding one of the transfer switches 13-1, 13-2, . . . , 13-m, 23-1, 23-2, . . . , 23-m.

The transistors 11-1, 11-2, . . . , 11-m, 21-1, 21-2, . . . , 21-m serve as horizontal select switches each adapted to select a pixel signal stored on a corresponding one of the line memories 12-1, 12-2, . . . , 12-m, 22-1, 22-2, . . . , 22-m. The transistors 11-1, 11-2, . . . , 21-1, 21-2, . . . , 21-m are configured to be turned on or off by output signals of the horizontal scanning circuit 10 and 20. Hereinafter, each of the transistors 11-1, 11-2, . . . , 11-m, 21-1, 21-2, . . . , 21-m is referred to as the horizontal transfer switch.

Each pair of adjacent horizontal select switches 11-1 and 11-2, 11-2 and 11-3, . . . , 11-(m-1) and 11-m is turned on or off by the same horizontal select signal. Likewise, each pair of adjacent horizontal select switches 21-1 and 21-2, 21-2 and 21-3, . . . , 21-(m-1) and 21-m is turned on or off by the same horizontal select signal.

The output channel CH1 is adapted to read pixel signals through the odd-numbered select switches 11-1, 11-3, . . . , 11-(m-1) of the horizontal select switches 11-1, 11-2, . . . , 11-m. The output channel CH2 is adapted to read pixel signals through the even-numbered select switches 11-2, 11-4, . . . , 11-m. The output channel CH3 is adapted to read pixel signals through the odd-numbered select switches 21-1, 21-3, . . . , 21-(m-1) of the horizontal select switches 21-1, 21-2, . . . , 21-m. The output channel CH4 is adapted to read pixel signals through the even-numbered select switches 21-2, 21-4, . . . , 21-m.

The horizontal scanning circuit 10 is composed of units 10-1, 10-2, . . . , 10-(m/2) in order to control the horizontal select switches 11-1, 11-2, . . . , 11-m two at a time as described previously. Each unit corresponds to ½ in the number of horizontal pixels. Likewise, the horizontal scanning circuit 20 is composed of units 20-1, 20-2, . . . , 20-(m/2) in order to control the horizontal select switches 21-1, 21-2, . . . , 21-m two at a time.

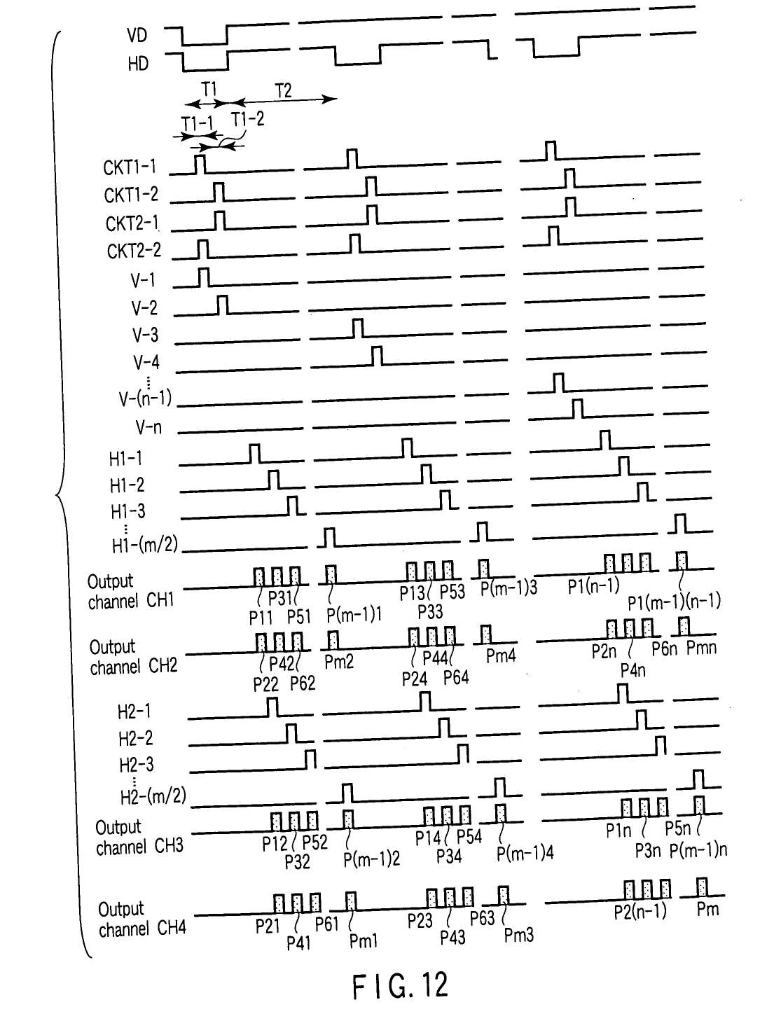

Reference is next made to the timing diagrams of FIGS. 11 and 12 to describe the characteristic operations of the imaging device 102 thus configured in detail. FIG. 11 shows the operation in the two-channel readout mode and FIG. 12 shows the operation in the four-channel readout mode.

Before describing the operation, we define symbols used in FIGS. 11 and 12.

In FIGS. 11 and 12, VD stands for a vertical sync signal and HD a horizontal sync signal. CKT1-1 represents a transfer signal which controls the odd-numbered transfer switches 13-1, 13-3, . . . , 13-(m-1). CKT1-2 represents a transfer signal which controls the even-numbered transfer switches 13-2, 13-4, . . . , 13-m. CKT2-1 represents a transfer signal which controls the odd-numbered transfer switches 23-1, 23-3, . . . , 23-(m-1). CKT1-1 represents a transfer signal which controls the even-numbered transfer switches 23-2, 23-4, . . . , 23-m.

V-1, . . . , V-n indicate row select signals output from the vertical scanning circuit 30. H1-1, . . . , H1-(m/2) represent horizontal select signals which are output from the units 10-1, 10-2, . . . , 10-(m/2) of the horizontal scanning circuit 10 to control the horizontal select switches 11-1, 11-2, . . . , 11-m. H2-1, . . . , H2-(m/2) represent horizontal select signals which are output from the units 20-1, 20-2, . . . , 20-(m/2) of the horizontal scanning circuit 10 to control the horizontal select switches 21-1, 21-2, . . . , 21-m. CH1 through CH4 also represent pixel signals output from the output channels.

The operation in the two-channel readout mode will be described in detail below with reference to FIG. 11.

In the two-channel readout mode, when a row select signal V-1 goes high during a horizontal blanking period T1, the pixels P11, P21, . . . , Pm1 in the first row are selected. At this point, the transfer signals CKT1-1 and CKT2-2 are at a high level and the transfer signals CKT1-2 and CKT2-1 are at a low level. Thus, pixel signals from the odd-numbered pixels P11, P31, . . . , P(m-1)1 of the selected pixels P11, P21, Pm1 are stored into the odd-numbered line memories 12-1, 12-3, . . . , 12-(m-1), respectively, of the line memories 12-1, 12-2, . . . , 12-m. Pixel signals from the even-numbered pixels P21, P41, . . . , Pm1 are stored into the even-numbered line memories 22-2, 22-4, . . . , 22-m, respectively, of the line memories 22-1, 22-2, . . . , 22-m.

After that, the horizontal scanning circuits 10 and 20 are placed in operation during a horizontal scanning period T2.

The horizontal scanning circuit 10 outputs the horizontal select signals H1-1, H1-2, . . . , H1-(m/2) in sequence from the units 10-1, 10-2, . . . , 10-(m/2), whereupon the pixel signals from the pixels P11, P31, . . . , P(m-1)1 stored in the odd-numbered line memories 12-1, 12-3, . . . , 12-(m-1) are output in sequence onto the output channel CH1.

On the other hand, the horizontal scanning circuit 20 outputs the horizontal select signals H2-1, H2-2, . . . , H2-(m/2) in sequence from the units 20-1, 20-2, . . . , 20-(m/2), whereupon the pixel signals from the pixels P21, P41, . . . , Pm1 stored in the even-numbered line memories 22-2, 22-4, . . . , 22-m are output in sequence onto the output channel CH4.

In the subsequent operation, the pixels in each of the second through n-th rows are selected during a horizontal blanking period. During a horizontal scanning period, pixel signals from odd-numbered pixels in a row are output onto the channel CH1 and pixel signals from even-numbered pixels in that row are output onto the channel CH4. That is, in the first drive mode, signals from two adjacent pixels in the same row are read in parallel onto the two output channels.

The operation timing of the horizontal scanning circuit 20 is displaced in phase by 180 degrees relative to that of the horizontal scanning circuit 10. For this reason, signals on the output channels CH1 and CH4 can be mixed later with certainty.

Next, the operation in the four-channel readout mode will be described in detail with reference to FIG. 12.

In the four-channel readout mode, when a row select signal V-1 goes high during the first half period T1-1 of a horizontal blanking period T1, the pixels P11, P21, . . . , Pm1 in the first row are selected.

At this point, the transfer signals CKT1-1 and CKT2-2 are at a high level and the transfer signals CKT1-2 and CKT2-1 are at a low level. Thus, pixel signals from the odd-numbered pixels P11, P31, . . . , P(m-1)1 of the selected pixels P11, P21, . . . , Pm1 are stored into the odd-numbered line memories 12-1, 12-3, . . . , 12-(m-1), respectively, of the line memories 12-1, 12-2, . . . , 12-m. Pixel signals from the even-numbered pixels P21, P41, . . . , Pm1 are stored into the even-numbered line memories 22-2, 22-4, . . . , 22-m, respectively, of the line memories 22-1, 22-2, . . . , 22-m.

During the subsequent second half period T1-2 a row select signal V-2 goes to a high level, whereupon the pixels P12, P22, . . . , Pm2 in the second row are selected.

At this point, the transfer signals CKT1-2 and CKT2-1 are at a high level and the transfer signals CKT1-1 and CKT2-2 are at a low level. Thus, pixel signals from the odd-numbered pixels P12, P32, . . . , P(m-1)2 of the selected pixels P12, P22, . . . , Pm2 are stored into the odd-numbered line memories 22-1, 22-3, . . . , 22-(m-1), respectively, of the line memories 22-1, 22-2, . . . , 22-m. Pixel signals from the even-numbered pixels P22, P42, . . . , Pm2 are stored into the even-numbered line memories 12-2, 12-4, . . . , 12-m, respectively, of the line memories 12-1, 12-2, . . . , 12-m.

After that, the horizontal scanning circuits 10 and 20 are placed in operation during a horizontal scanning period T2.

The horizontal scanning circuit 10 outputs the horizontal select signals H1-1, H1-2, . . . , H1-(m/2) in sequence from the units 10-1, 10-2, . . . , 10-(m/2), whereupon the pixel signals from the pixels P11, P31, . . . , P(m-1)1 stored in the odd-numbered line memories 12-1, 12-3, . . . , 12-(m-1) of the line memories 12-1, 12-2, . . . , 12-m are output in sequence onto the output channel CH1. The pixel signals from the pixels P22, P42, . . . , Pm2 stored in the even-numbered line memories 12-2, 12-4, . . . , 12-m are output in sequence onto the output channel CH2. On the other hand, the horizontal scanning circuit 20 outputs the horizontal select signals H2-1, H2-2, . . . , H2-(m/2) in sequence from the units 20-1, 20-2, . . . , 20-(m/2), whereupon the pixel signals from the pixels P12, P32, . . . , P(m-1)2 stored in the odd-numbered line memories 22-1, 22-3, . . . , 22-(m-1) of the line memories 12-1, 12-2, . . . , 12-m are output in sequence onto the output channel CH3. The pixel signals from the pixels P21, P41, . . . , Pm1 stored in the even-numbered line memories 22-2, 22-4, . . . , 22-m are output in sequence onto the output channel CH4.

In the subsequent operation, every two rows of pixels in the third through n-th rows are selected during each successive horizontal blanking period. During a horizontal scanning period, pixel signals from pixels in an odd-numbered row and odd-numbered columns are output onto the channel CH1. Pixel signals from pixels in that odd-numbered row and even-numbered columns are output onto the channel CH4. Pixel signals from pixels in an even-numbered row and odd-numbered columns are output onto the channel CH2. Pixel signals from pixels in that even-numbered row and even-numbered columns are output onto the channel CH2. That is, in the four-channel readout mode, pixel signals from each block of 2×2 pixels are read in parallel onto the four output channels.

In the So-called Bayer Array, as shown in FIG. 3, green (G) color filters are arranged every other pixel in the horizontal and vertical directions so as to form a checkered pattern. Red (R) and blue (B) color filters are arranged on alternate rows so as to cover each pixel interposed between pixels covered with green color filters. Therefore, the use of color filters in the So-called Bayer Array allows the output channels to be divided for each color, thus making postprocessing easy.

As described above, operating the imaging device 102 configured as shown in FIG. 10 at times shown in FIGS. 11 and 12 allows the number of output channels to be selectively changed. In addition, pixel signals from pixels in odd- and even-numbered columns are output onto the output channels at different times (in different phases), allowing a subsequent mixing process to be performed with certainty.

### Second Embodiment

In the first embodiment, the gains of the amplifiers are lowered to ½ in order to exactly read saturation output values. Unlike the first embodiment, the second embodiment is configured to determine the correction coefficients with the gains of the amplifiers kept at unity. The corresponding parts to those in the first embodiment are denoted by like reference characters and detailed descriptions thereof are omitted.

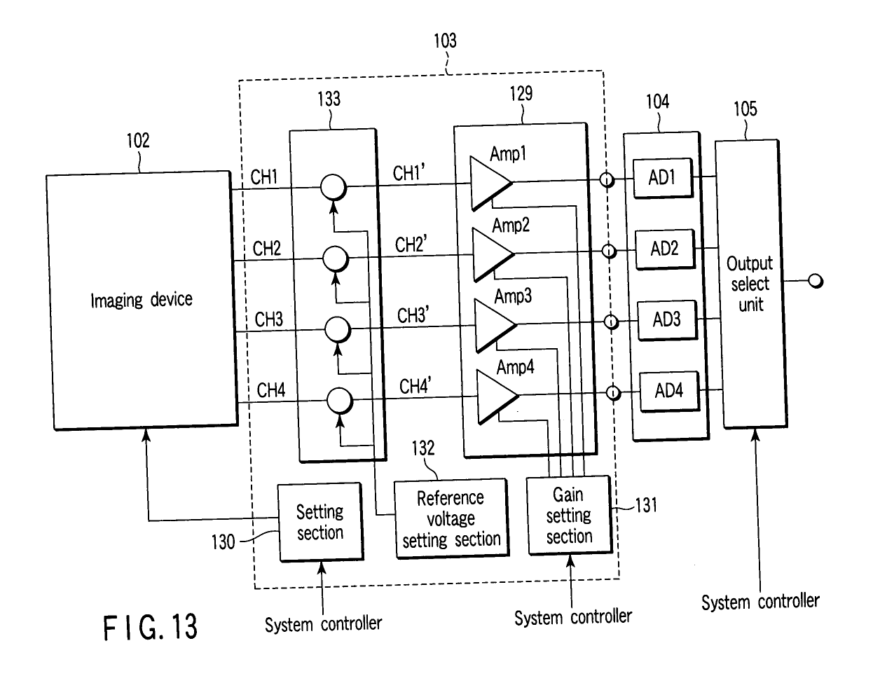

FIG. 13 shows the imaging circuit 103 and its associated circuits.

This imaging circuit differs from the imaging circuit of the first embodiment shown in FIG. 2 in that a reference voltage setting section 132 and a switching section 133 are added. The reference voltage setting section 132 supplies a predetermined voltage to the switching section 133 connected to the output channels of the imaging device 102. The switching section 133 supplies a voltage equal to the difference between the voltage from the reference voltage setting section 132 and a signal voltage on each of the output channels of the imaging device 102 to a corresponding one of the amplifiers Amp1 through Amp4.

The processing as described in the first embodiment is performed on signals from the outputs CH (CH1′, CH2′, CH3′, CH4′) of the switching section 133. That is, the second embodiment, while being added with the reference voltage setting section 132 and the switching section 133, remains unchanged from the first embodiment in the inventive technical concept that signal processing is performed based on signals from the outputs CH (CH1, CH2, CH3, CHH4) of the imaging device 102.

Though not shown, the operation of the switching section 133 to produce differential voltages is performed under the instructions of the system controller 110. At image capture time, pixel signals output from the imaging device which form an image signal are clamped with the output of an optically black portion (composed of light-tight pixels) which is not used to form the image signal as an image signal black level reference signal.

Next, the method of reading saturation outputs according to the second embodiment will be described. The imaging device 102 is assumed here to be a CMOS device.

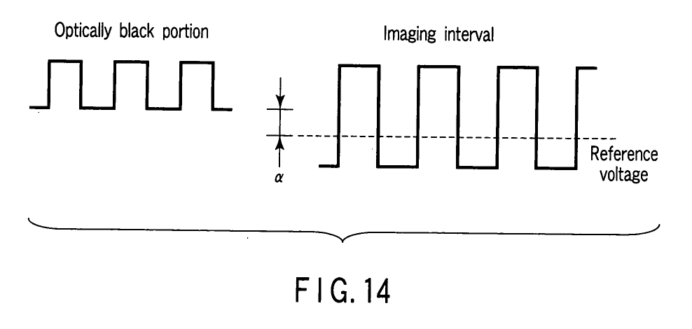

FIG. 14 shows CMOS output waveforms from an optically black portion (not shown) composed of light-tight pixels and the image signal forming pixels. As described above, the signal from the optically black portion is the image signal black level reference signal. As the result, the image signal has its voltage level dropped by the black level reference signal.

This concept is applied to reading of saturation output values. That is, the reference voltage from the reference voltage setting section 132 is applied to the switching section instead of the black level reference signal during a time interval for the optically black portion. By so doing, a CMOS output signal during an imaging interval has its voltage level dropped by the reference voltage. Thus, if a saturation signal is clamped with a reference signal at a predetermined level, it will have a readable level, that is, a level within the range that the analog-to-digital converter 104 can accommodate.

The above operation can be grasped as an application of the so-called CDS (correlated double sampling) which reduces noise by taking a difference in CMOS output level between an interval (feedthrough interval) when charges are reset and an interval (signal interval) when signals are output. Therefore, the switching section 133 can be configured with the CDS circuit as a basis.

When saturation output values are read in according to this method, the operation indicated in expression (2) cannot be used in calculating the correction coefficients gi. In this case, an expression (4) which takes into consideration the reference voltage α is simply used.
gi=Max(S1+α, S2+α, S4+α)/(si+α) (4)
The magnitude of the reference voltage itself may also be obtained by analog-to-digital conversion with reference to the black level.

### Advantages of the Embodiments

According to the embodiments described above, after output signals of the imaging device have reached the saturation level, the gains of the amplifiers are adjusted using the saturation signals. Therefore, the gain adjustment is not affected by the characteristics and type of the adjustment light source and variations in the illuminance of the light source.

In addition, the amplifier gain adjustment can be made independently of colors, thus allowing the signal dynamic range to be employed effectively.

Furthermore, the imaging device has a light receiving unit in which filters of at least three colors are arranged on the pixels. The imaging device is configured so as to enable switching between two-output readout and four-output readout. When the two-output readout is selected, pixel signals from each line are alternately output onto the two outputs. When the four-channel readout is selected, pixel signals of the same color from lines are output onto a corresponding respective one of the four outputs.

For this reason, conversion to a display image can be made easy and the effect of variations little occurs. Thus, the display quality is good. Furthermore, since corrections are made on the basis of a signal amount of saturation level which is independent of color information, thus suffers no restrictions due to the filter arrangement.

The So-called Bayer Array is applicable to the filter arrangement; however, this is not restrictive. The present invention can be widely used in handling signals from a device that outputs multi-channel signals each having a periodical color arrangement.

Each function described in the above embodiments may be implemented in hardware or software. In the case of software, a program describing each function is read into a computer. Also, each function may be implemented by selecting either hardware or software.

Furthermore, each function can also be implemented by reading a program stored on a recording medium not shown into a computer. In the embodiments, any form of recording medium may be used provided that it can record programs and can be read by a computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image capture device comprising:
an imaging unit which includes a plurality of output terminals and a light receiving unit composed of a plurality of pixels arranged in the form of an array of columns and rows and each having a photoelectric conversion element which, upon receiving light, produce a photoelectric conversion output signal, and wherein the imaging unit is configured to output photoelectric conversion output signals from the pixels onto the output terminals;
signal amplifiers each of which is connected to a corresponding respective one of the output terminals of the imaging unit;
a detection unit which, after the photoelectric conversion output signals have reached a saturation level, detects the magnitude of saturation output signals from the output terminals of the imaging unit; and
a setting unit which sets the gains of the respective signal amplifiers so that the saturation output signals detected by the detection unit become equal in magnitude to one another.

2. The image capture device according to claim 1, wherein, when the detection unit detects the magnitude of saturation output signals, the setting unit sets the gains of the respective signal amplifiers low so as to allow the detection unit to detect the magnitude of saturation output signals.

3. The image capture device according to claim 1, wherein the light receiving unit further includes color filters arranged on the pixels, and the imaging unit outputs onto each of its output terminals photoelectric conversion signals from pixels on which color filters of the same color are arranged.

4. The image capture device according to claim 1, further comprising a select unit configured to select output terminals out of the output terminals of the imaging unit so that the photoelectric conversion output signals are output onto the selected output terminals.

5. The image capture device according to claim 4, wherein the imaging unit has filters of at least three colors arranged on the pixels in the light receiving unit and four output terminals, and the select unit selects either two output terminals or four output terminals of the imaging unit, and the imaging unit is configured so that, when the two output terminals are selected, pixel signals from each line are alternately output onto the two outputs and, when the four outputs are selected, pixel signals of the same color from lines are output onto a corresponding respective one of the four outputs.

6. The image capture device according to claim 1, further comprising AD conversion unit which converts analog signals output from the signal amplifiers into digital signals, and wherein the gains of the signal amplifiers are set so that the saturation output signals from the output terminals of the imaging unit become equal to each other in magnitude within the AD input range of the AD conversion unit.

7. The image capture device according to claim 6, wherein the gains of the signal amplifiers are set so that the saturation output signals become equal in magnitude to the maximum value of the saturation output signals.

8. The image capture device according to claim 1, wherein, when the detection unit detects the magnitude of the saturation output signals, the setting unit sets the gains of the signal amplifiers to one different from a gain set at image capture time.

9. The image capture device according to claim 1, further comprising a reference voltage setting unit which sets a voltage of predetermined magnitude as a reference voltage, and wherein, when the detection unit detects the magnitude of the saturation output signals, the output signals of the imaging unit are lowered by the reference voltage before being amplified by the signal amplifiers.

10. An image capture device comprising:
an imaging unit which includes a plurality of output terminals and is configured to output image information having color information onto the output terminals;
a select unit which selects output terminals out of the output terminals of the imaging unit onto which image information captured by the imaging unit are to be output;
a setting unit which sets the gains of signals output onto the selected output terminals of the imaging unit so that saturation output signals output from the selected output terminals become equal to each other in magnitude; and
an AD converter unit which converts image information amplified on the basis of the gains set by the setting unit from analog to digital form.

11. The image capture device according to claim 10, wherein the gains of the signals are set so that the saturation output signals from the output terminals of the imaging unit become equal to each other in magnitude within the AD input range of the AD conversion unit.

12. The image capture device according to claim 11, wherein the gains of the signal amplifiers are set so that the saturation output signals become equal in magnitude to the maximum value of the saturation output signals.

13. The image capture device according to claim 10, wherein the imaging unit has a light receiving unit on which filters of at least three colors are arranged and four output terminals, and the select unit selects either two output terminals or four output terminals of the imaging unit, and the imaging unit is configured so that, when the two output terminals are selected, pixel signals from each line are alternately output onto the two outputs and, when the four outputs are selected, pixel signals of the same color from lines are output onto a corresponding respective one of the four outputs.

14. An image capture device comprising:
imaging means which includes a plurality of output terminals and a light receiving unit composed of a plurality of pixels arranged in the form of an array of columns and rows and each having a photoelectric conversion element which, upon receiving light, produces a photoelectric conversion output signal, wherein the imaging means is configured to output photoelectric conversion output signals from the pixels onto the output terminals;
signal amplifying means each of which is connected to a corresponding respective one of the output terminals of the imaging means;
detecting means for, after the photoelectric conversion output signals have reached a saturation level, detecting the magnitude of saturation output signals from the output terminals of the imaging means; and
setting means for setting the gains of the respective signal amplifying means so that the saturation output signals detected by the detecting means become equal in magnitude to one another.

15. An image capture device comprising:
imaging means which includes a plurality of output terminals and is configured to output image information having color information onto the output terminals;
selecting means for selecting output terminals out of the output terminals of the imaging means onto which image information captured by the imaging means are to be output;
setting means for setting the gains of signals output onto the selected output terminals of the imaging means so that saturation output signals output from the selected output terminals become equal to each other in magnitude; and
AD conversion means for converting image information amplified on the basis of the gains set by the setting means from analog to digital form.
